(19) United States
(12) Patent Application Publication
(10) Pub. No.: US 2020/0108968 A1
(43) Pub. Date: Apr. 9, 2020

(54) PROPORTIONALY DIMENSIONED REUSABLE VESSEL

(71) Applicant: Craft Packaging LLC, Draper, UT (US)

(72) Inventors: Travis Winn, Draper, UT (US); Katie Addison, Draper, UT (US); Brennan Crellin, Draper, UT (US); Tyler Winn, Draper, UT (US)

(73) Assignee: Craft Packaging LLC, Draper, UT (US)

(21) Appl. No.: 16/596,464

(22) Filed: Oct. 8, 2019

Related U.S. Application Data
(60) Provisional application No. 62/742,752, filed on Oct. 8, 2018.

(51) Int. Cl. B65D 1/14; B65D 51/24

(52) U.S. Cl. CPC B65D 1/14; F21V 35/00; B65D 51/24

(57) ABSTRACT

Disclosed herein is a system including a vessel. The vessel includes an outside diameter, an inside diameter, a height, a thickness, and a top surface. Further provided is a body which may be disposed within the vessel. The vessel includes an outside diameter that is commensurate to an inside diameter of the vessel, the body including a bell portion which mates with a top surface of the vessel such that the body is flush with the vessel in a vertical and horizontal direction.

### CROSS-REFERENCE TO RELATED APPLICATIONS

This application claims the benefit of U.S. Provisional Application No. 62/742,752, filed Oct. 8, 2018, which is incorporated herein by reference in its entirety, including but not limited to those portions that specifically appear hereinafter, the incorporation by reference being made with the following exception: In the event that any portion of the above-referenced provisional application is inconsistent with this application, this application supersedes said above-referenced provisional application.

### BACKGROUND

### 1. Technical Field

This disclosure relates generally to a system, device, and kit that includes a vessel that receives a plurality of proportionally sized items to enhance the reusability of the vessel. The vessel may be appropriately dimensioned to accept and retain, in an upright manner, a variety of supplemental accoutrements. One example of a supplemental accoutrement may be a fragrance diffuser. Another example of a supplemental accoutrement may be a soap or lotion pump. Another example of a supplemental accoutrement may be a candle holder. The reusable vessel may be dimensionally sized to accommodate these, and other, supplemental accoutrements in a manner that ensures the supplemental accoutrements are both stylish in presentation and adequately contained to ensure that the supplemental accoutrements may be used as intended and desired.

### 2. Description of the Related Art

Vessels, in modern times, are ubiquitous but generally specifically purposed. For example, liquid soap dispensers are frequently manufactured in a package that is generally single use. Once the soap has been used and the soap dispenser is empty, the package that contained the soap is thrown away. The soap dispensers are typically packaged based on packaging costs rather than style and, for some, can be an eyesore when disposed on a sink, where a soap dispenser is typically useful. The same can be said of lotion pumps which are also generally single use packages and which is generally thrown away when empty. Further, the packaging for the soap dispenser and the packaging for the lotion pump may be quite different from each other. For example, a lotion pump may be taller than a soap dispenser and a soap dispenser may be more bulbous than a lotion pump. In short, the lotion pump and the soap dispenser do not match and may detract from a sense of coherence, style, and design in a particular room.

In a typical bathroom, for example, typical items that may be found include a soap dispenser, a lotion pump, a candle, a fragrance diffuser, and other items. However, these items, when all provided on a sink or a toilet tank tend to create a cluttered and disorganized look what, but for the items, would be a pleasant well designed and decorated space. Since each of these items are manufactured by, generally, different companies, and are generally essential for societal hygiene expectations, it is desirable to provide these items in a manner that improves the overall ambience and experience of a particular room. Other rooms in a home, office, or other area could similarly benefit from consistent, organized, and intentional design elements that match or are consistent with an overall room design.

It is therefore desirable to provide a vessel which is dimensionally sized such that it can receive a plurality of different items. It is a further object of this disclosure to ensure that each of the plurality of items may be dimensionally sized and weighted to ensure that the plurality of items are supported in an upright position when in use. It is a further object of this disclosure to provide items dimensionally sized to complement the vessel such that the vessel may be used with any of the plurality of items.

### SUMMARY

Disclosed herein is a system including a vessel. The vessel includes an outside diameter, an inside diameter, a height, a thickness, and a top surface. Further provided is a body which may be disposed within the vessel. The vessel includes an outside diameter that is commensurate to an inside diameter of the vessel, the body including a bell portion which mates with a top surface of the vessel such that the body is flush with the vessel in a vertical and horizontal direction.

Further disclosed herein is a kit. The kit includes a vessel. The vessel includes an outside diameter, an inside diameter, a height, a thickness, and a top surface. Further provided is a pump having a pump body. The pump body includes an outside diameter that is commensurate with an inside diameter of the vessel. The pump body includes a bell portion which mates with a top surface of the vessel such that the pump body is flush with the vessel in a vertical and horizontal direction. Further provided is a diffuser having a diffuser body. The diffuser body includes an outside diameter that is commensurate with an inside diameter of the vessel. The diffuser body further includes a bell portion which mates with a top surface of the vessel such that the diffuser body is flush with the vessel in a vertical and horizontal direction. Further provided is a candle holder. The candle holder includes an outside diameter that is commensurate to an inside diameter of the vessel. The candle holder includes a candle mount and an extension portion that extends downwardly from a bottom of the candle mount.

### BRIEF DESCRIPTION OF THE DRAWINGS

The accompanying drawings illustrate various embodiments of a proportionally dimensioned reusable vessel disclosed herein.

FIG. 1 illustrates a vessel.

FIG. 2 illustrates a lotion pump for use with the vessel.

FIG. 3 illustrates a fragrance diffuser for use with the vessel.

FIG. 4 illustrates a candle holder for use with the vessel.

FIG. 5A illustrates a bottom view of a cap for the vessel.

FIG. 5B illustrates a top view of a cap for the vessel.

FIG. 6 illustrates a lotion pump disposed in the vessel.

FIG. 7 illustrates a fragrance diffuser disposed in the vessel.

FIG. 8A illustrates a candle holder disposed in the vessel.

FIG. 8B illustrates an inset view of a bottom portion of the candle holder in a bottom portion of the vessel.

### DETAILED DESCRIPTION OF PREFERRED EMBODIMENTS

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

As defined herein the term “complement” or “complementary” means that one object may fit inside another object with less than 10 mm of difference between surfaces of the objects. The term “substantially equal” means that items or dimensions identified as “substantially equal” have dimensions that are within (or less than) 2% of each other. The term “equal” is subsumed in the term “substantially equal” and further means that the items or dimensions identified as “equal” are equal with variances allowed for manufacturing tolerances which is typically within thousandths of an inch.

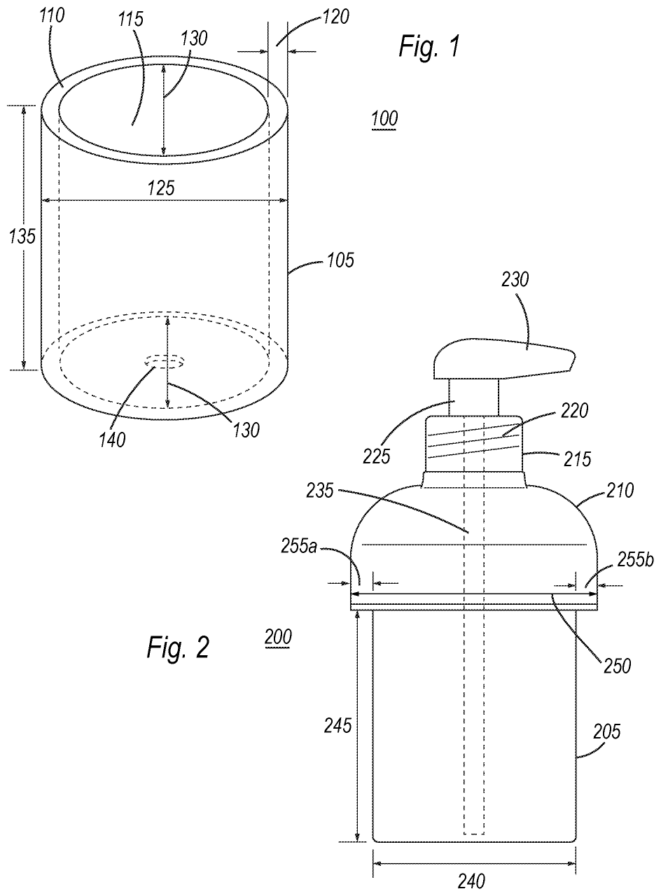

FIG. 1 illustrates a vessel 100. Vessel 100 may be manufactured using a variety of materials and constructions. For example, in one embodiment, vessel 100 may be implemented using concrete. Other materials, such as metal, wood, plastic, or stone may also be used to implement vessel 100. Vessel 100 may include a body 105 that defines an outside surface and structure of vessel 100. Body 105 may be generally circular, or conical but need not be. Body 105 may be implemented in any polygonal shape according to intended design preferences. Vessel 105 includes a top surface 110 which may provide a surface that defines a thickness of vessel 100 between an outside surface of body 105 and a void 115 within vessel 100, the thickness being identified as thickness 120.

Vessel 100 may include have a diameter, or width depending on shape, which defines an outside diameter 125. Similarly, void 115 defines an inside diameter 130 of vessel 100. Vessel 100 further includes a base that defines a height 135 of vessel 100 from a bottommost portion of the base to top surface 110. Vessel 100 may further include an air hole 140 which prevents vacuum pressure from forming within vessel 100, as will be further discussed below.

FIG. 2 illustrates a lotion pump 200 to be used with vessel 100, shown in FIG. 1. It is to be noted at this point that lotion pump 200 need not only pump lotion. Any relatively high viscosity liquid may be pumped using lotion pump 200, such as soap, shaving soap or cream, hair gel, cologne, perfumes, or any other fluid. Lotion pump 200 may be constructed using plastic, glass, ceramic, porcelain, metal, or any other appropriate material. Lotion pump 200 may include a body 205 and a bell portion 210. Bell portion 210 may include a curvature that resembles a bell or, alternatively, provides a curvature that is symmetric about a vertical axis of lotion pump 200. Lotion pump 200 may be fitted with a cap 215 that includes threads 220 that made with corresponding threads 220 on bell portion 210 of body 205. Cap 215 may include a pump shaft 225 and a pump head 230 which, through pumping, allows a user to receive lotion, for example, contained within lotion pump 200 via pump head 230. Cap 215 may also include a shaft or straw 235 which extends into lotion pump 200 to suck lotion, for example, from lotion pump 200.

Lotion pump 200 may be dimensionally complementary to vessel 100, shown in FIG. 1. For example, body 205 may include an outside diameter 240 which complements an inside diameter 130 of vessel 100. Further, body 205 may include a height 245 which complements height 135 of vessel 100, shown in FIG. 1. Bell portion 210 may include a maximum outside diameter 250 for lotion pump 200 which complements an outside diameter 125 of vessel 100, shown in FIG. 1. As shown in FIG. 2, an outside diameter of body portion 205 is less than an outside diameter of bell portion 210. A difference in diameter between the outside diameter of bell portion 210 and outside diameter of body portion 205 is divided in half, as shown by distance 255a and distance 255b, which are equal. In other words, a bottom of bell portion 210 may be substantially flat and have a distance/length 255a or 255b which complements thickness 120 of body 105 of vessel 100, shown in FIG. 1. Distance 255a and distance 255b may also be substantially equal to thickness 120 of body 105 of vessel 100. Distance 255a and distance 255b may also be equal to thickness 120 of body 105 of vessel 100.

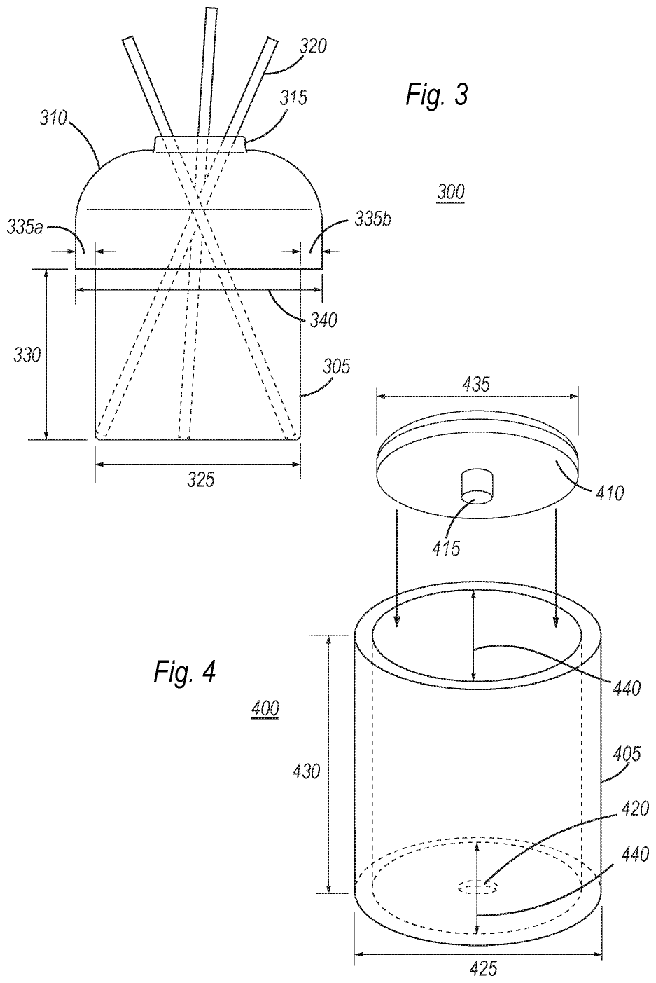

FIG. 3 illustrates a fragrance diffuser 300 for use with vessel 100, shown in FIG. 1. Fragrance diffuser 300 may be constructed using plastic, glass, ceramic, porcelain, metal, or any other appropriate material. Fragrance diffuser 300 includes a body 305 and a bell portion 310. Bell portion 310 may include a curvature that resembles a bell or, alternatively, provides a curvature that is symmetric about a vertical axis of lotion pump of fragrance diffuser 300. Bell portion 310 may further include a neck 315 which provides an opening into fragrance diffuser 300. Fragrance diffuser 300 may include one or more diffuser reeds 320 which function to draw aromatic or fragrant liquid from within fragrance diffuser 300 up through the reeds which disperse a fragrance/aroma in an environment around fragrance diffuser 300.

Fragrance diffuser 300 may be dimensionally complementary to vessel 100, shown in FIG. 1. For example, body 305 may include an outside diameter 325 which complements an inside diameter 130 of vessel 100. Further body 305 may include a height 330 which complements height 135 of vessel 100, shown in FIG. 1. Bell portion 310 may include a maximum outside diameter 340 for fragrance diffuser 300 which complements an outside diameter 125 of vessel 100, shown in FIG. 1. As shown in FIG. 3, an outside diameter of body portion 305 is less than an outside diameter of bell portion 310 and outside diameter of body 305 is less than an outside diameter of bell portion 310. A difference in diameter between the outside diameter of bell portion 310 and outside diameter of body 305 is divided in half, as shown by distance 335a and distance 335b, which are equal. In other words, a bottom of bell portion 310 may be substantially flat and have a distance/length 335a and distance 335b, which complements thickness 120 of body 105 of vessel 100, shown in FIG. 1. Distance 335a and distance 335b may also be substantially equal to thickness 120 of body 105 of vessel 100. Distance 335a and distance 255b may also be equal to thickness 120 of body 105 of vessel 100.

FIG. 4 illustrates a candle holder 400 for use with vessel 100, shown in FIG. 1. Candle holder 400 may be constructed using plastic, glass, ceramic, porcelain, metal, or any other appropriate material. Candle holder 400 includes a body 405. Candle holder 400 may further include a candle mount 410 which includes an extended portion 415. Candle mount 410 may be disposed within candle holder 400, may be removable, or may not be included depending on a particular implementation of candle holder 400. Candle holder 400 may further include an aperture 420 for accommodating extended portion 415 of candle mount 410.

As shown in FIG. 4, candle holder 400 may be dimensionally complementary to vessel 100, shown in FIG. 1. For example, candle holder 405 may include an outside diameter 425 which complements an inside diameter 130 of vessel 100, shown in FIG. 1. Body 405 may include a height 430 which complements height 135 of vessel 100, shown in FIG. 1. In one embodiment, an outside diameter of candle mount 435 may complement an inside diameter 440 of candle holder 400.

In this manner, candle mount 410 may be inserted into candle holder 400 and rest on a bottom of body 405. In practice, a candle may be disposed on candle mount 410 and may be burned until exhausted. As the candle burns, wax may drip over candle mount 410 which may cause difficulty in removing the candle and the candle wax from candle holder 400. To facilitate removal of candle mount 410 from candle holder 400, especially when covered in wax, a user may apply pressure to extension portion 415 and force candle mount 410 out of candle holder 400 from a bottom of candle holder 400 through aperture 420.

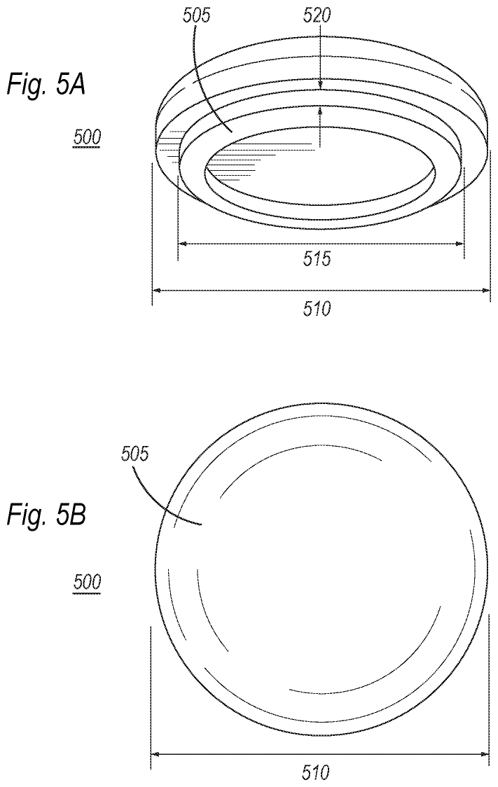

FIG. 5A illustrates a bottom view of a cap 500 for vessel 100, shown in FIG. 1. Cap 500 may be made from any material, including concrete, glass, ceramic, porcelain, plastic, metal, cork (or other wood), stone, and any other suitable material. Cap 500 includes a ring 505 which may extend from a bottom surface of cap 500 away from cap 500. Cap 500 may include an outside diameter 510 that is complementary with outside diameter 125 of vessel 100, shown in FIG. 1. Ring 505 may an outside diameter 515 that is complementary with an inside diameter 130 of vessel 100, shown in FIG. 1. Ring 505 may be raised a distance 120 (e.g., extend from a bottom surface of cap 500 away from cap 500) from cap 500. In this manner, ring 505 extends into vessel 100 when installed on vessel 100.

FIG. 5B illustrates a top view of cap 500. Cap 500 includes ring 505 (not shown in FIG. 5B) on a bottom side of cap 500. Cap 500 also includes an outside diameter 510 that is complementary with an outside diameter 125 of vessel 100, shown in FIG. 1.

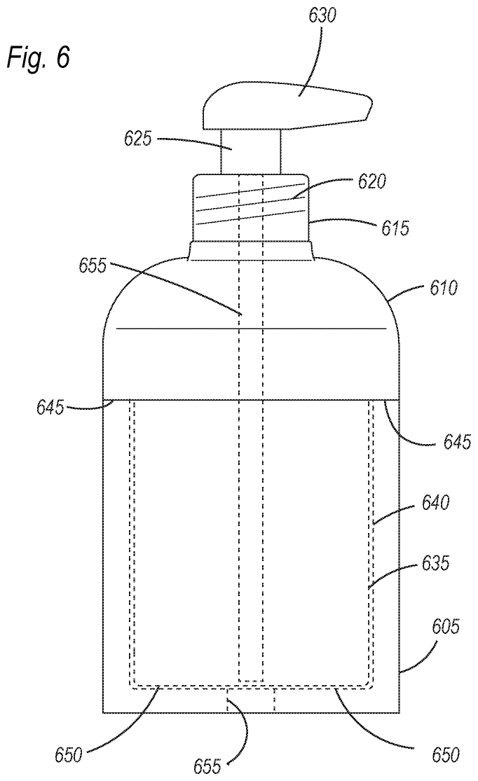

FIG. 6 illustrates a lotion pump, such as lotion pump 200, shown in FIG. 2, disposed in a vessel 100, shown in FIG. 1 as a pump system 600. Pump system 600 includes a vessel body 605 which includes a pump 610. Pump 610 further includes a cap 615, threads 620 for attaching cap 615 to pump 610, a pump shaft 625, a pump head 630, and a suction straw/tube 655 for drawing a liquid into cap 615. As shown in FIG. 6, pump 610 includes a pump body 635 which is disposed inside a vessel body 605.

Pump body 635 includes an outside diameter that is complementary, or substantially equal, to an inside diameter of inside wall 640 of vessel body 605. As further shown, pump 610 includes a bell portion, such as bell portion 210, shown in FIG. 2, which mates with vessel body 605 along a circumference 645 of a top of vessel body 605. A thickness of vessel body 605, identified as thickness 120 in FIG. 1, may be complementary, or substantially equal, to a distance between pump body 635 and an edge of the bell portion (element 255a/255b shown in FIG. 2) of pump body 635 such that bell portion (element 255a/255b shown in FIG. 2) rests on top 110 (shown in FIG. 1) of vessel body 605. In this manner, an edge of bell portion (255a/255b shown in FIG. 2) of pump body 635 is flush with an outside surface of vessel body 605 in a horizontal direction.

Further, a height of vessel body 605 (which is shown in FIG. 1 as height 135) may be commensurate, or substantially equal, to a height of pump body 635 such that pump body 635 rests on an inside surface of the bottom 650 of vessel body 650, as shown in FIG. 6. In this manner, an edge of bell portion (255a/255b shown in FIG. 2) of pump body 635 is flush with an outside surface of vessel body 605 in a vertical direction. Thus, pump 610 is mounted in vessel body 605 in a manner such that pump 610 is flush with an outside surface of vessel body 605 in a horizontal and vertical direction. Since the dimensions of the inside of vessel body 605 and the outside of pump body 635 are commensurate, or substantially equal, and since pump 610 rests on a top surface (110 in FIG. 1) of vessel body 605, a vacuum pressure may be created between vessel body 605 and pump 610. In order to relieve any potential vacuum pressure that could be created, aperture 655 is disposed in a base of vessel body 605 to allow air within vessel body 605 to be displaced upon insertion of pump 610 into vessel body 605 and replaced upon withdrawal of pump 610 from vessel body 605.

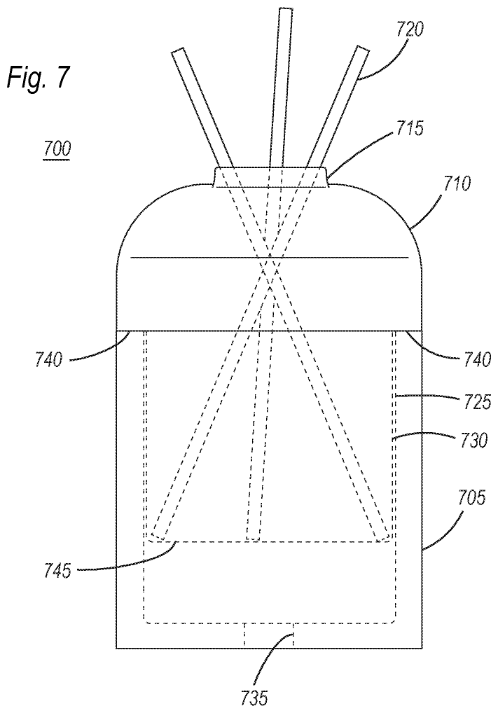

FIG. 7 illustrates a fragrance diffuser 710 disposed in vessel body 705 of system 700. As shown in FIG. 7, system fragrance diffuser 710 includes a neck 715 within which are disposed a plurality of reeds 720 which may be disposed within fragrance diffuser 710. Fragrance diffuser 710 may further contain an aromatic or fragrant substance which is drawn up into the reeds and emitted into the environment surrounding fragrance diffuser 710.

Fragrance diffuser 720 further includes a diffuser body 730 which includes an outside diameter that is complementary, or substantially equal, to an inside diameter of inside wall 725 of vessel body 705. As further shown, diffuser 710 includes a bell portion, such as bell portion 310, shown in FIG. 3, which mates with vessel body 705 along a circumference 740 of a top of vessel body 705. A thickness of vessel body 705, identified as thickness 120 in FIG. 1, may be complementary, or substantially equal, to a distance between diffuser body 730 and an edge of the bell portion (element 355a/355b shown in FIG. 3) of diffuser body 730 such that bell portion (element 355a/355b shown in FIG. 3) rests on top 110 (shown in FIG. 1) of vessel body 705. In this manner, an edge of bell portion (355a/355b shown in FIG. 3) of diffuser body 730 is flush with an outside surface of vessel body 705 in a horizontal direction.

As shown in FIG. 7, a height of diffuser body 730 (which is shown in FIG. 3 as height 330) may be less than a height of vessel body 605 such that a bell portion (element 335a/335b shown in FIG. 3) rests on a top surface (element 110 shown in FIG. 1) of vessel body 705 around a circumference of bell portion 740. Thus, a base 745 of diffuser body 730 is shown as having a height (height 330 in FIG. 3) that is less than half of the height of vessel body 705 (shown in FIG. 1 as element 135).

Since the dimensions of the inside of vessel body 705 and the outside of diffuser body 730 are commensurate, or substantially equal, and since pump 710 rests on a top surface (110 in FIG. 1) of vessel body 705, a vacuum pressure may be created between vessel body 705 and pump 710. In order to relieve any potential vacuum pressure that could be created, aperture 735 is disposed in a base of vessel body 705 to allow air within vessel body 705 to be displaced upon insertion of pump 710 into vessel body 705 and replaced upon withdrawal of pump 710 from vessel body 705.

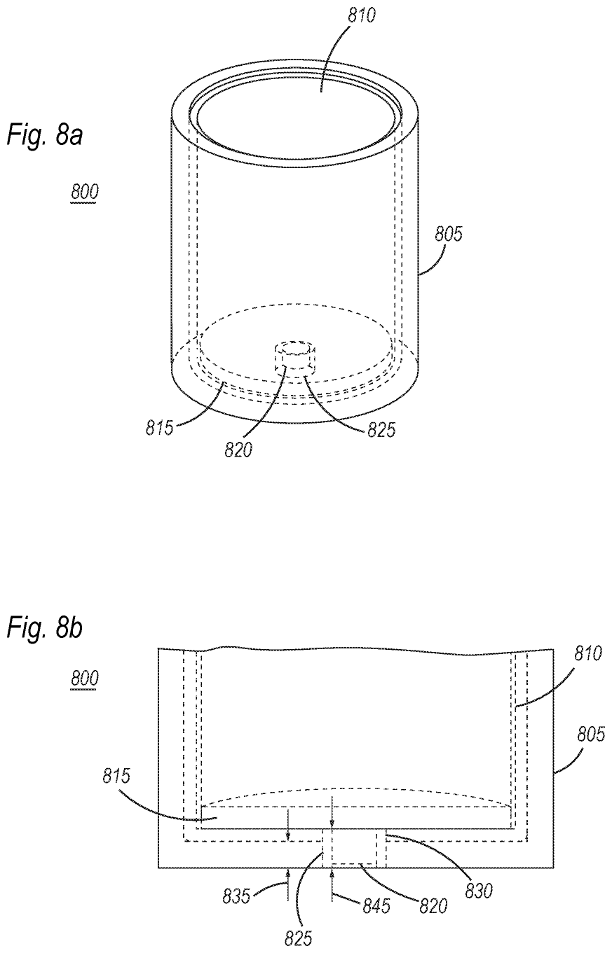

FIG. 8 illustrates a system 800 which provides a vessel body 805 (which is similar to vessel 100 shown in FIG. 1) and a candle holder 810. Candle holder 810 may have a height that is commensurate, or substantially equal, with a height of vessel body 805. Candle holder 810 may further provide a candle mount 815 which includes an extension portion 820. Extension portion 820 extends through an aperture 825 created in both the bottom of candle holder 810 and vessel body 805 which allows extension portion 820 to extend into a portion of aperture 825 created by vessel body 805. It should be noted, however, that extension portion 820 does not sit proud of a bottommost portion of vessel body 805 so as to ensure vessel body 805 may be in full contact with another surface without tipping or pushing candle mount 815 away from contact with a bottom of candle holder 810. FIG. 8B further illustrates this concept.

FIG. 8B illustrates an inset portion of FIG. 8A. As shown in FIG. 8B, vessel body 805 includes an internal wall which encloses candle holder 810. Candle holder 810 may further include a candle mount 815 which may be disposed within candle holder 810. Vessel body 805 further includes an aperture 825 while candle holder 810 includes an aperture 830. Aperture 825 and aperture 830 may be similarly sized and commensurate in shape. Vessel body includes a base thickness 835. Extension portion 820 may have a length 845. In the embodiment of FIG. 8B, length 845 of extension portion may be shorter than the base thickness 835 or, alternatively, may be shorter than base thickness 835 plus a thickness of candle holder 810 such that extension portion 820 does not extend past a bottommost portion of vessel body 805, as shown in FIG. 8B.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A system comprising:
a vessel having an outside diameter, an inside diameter, a height, a thickness, and a top surface;
a body, disposed within the vessel having an outside diameter that is commensurate to an inside diameter of the vessel, the body including a bell portion which mates with a top surface of the vessel such that the body is flush with the vessel in a vertical and horizontal direction.

2. The system of claim 1, wherein the vessel further includes an aperture.

3. The system of claim 2, wherein the aperture is disposed in a bottom surface of the vessel.

4. The system of claim 1, wherein the body is a pump body.

5. The system of claim 1, wherein the body is a diffuser body.

6. The system of claim 1, further comprising a cap.

7. The system of claim 6, wherein the cap has outside diameter that is commensurate with an outside diameter of the vessel.

8. The system of claim 7, wherein the cap further includes a ring extending from the cap.

9. The system of claim 8, wherein the ring has an outside diameter that is commensurate with an inside diameter of the vessel.

10. The system of claim 1, further comprising a candle holder.

11. The system of claim 10, wherein the candle holder has a height that is commensurate to a height of the vessel.

12. The system of claim 11, wherein the candle holder has an outside diameter that is commensurate with an inside diameter of the vessel.

13. The system of claim 12, wherein the candle holder further includes an aperture.

14. The system of claim 13, wherein the aperture of the candle holder is has an outside diameter that is commensurate with an inside diameter of an aperture in the vessel.

15. The system of claim 14, wherein the candle holder includes an extension portion that extends into the aperture.

16. The system of claim 10, wherein the candle holder includes an extension portion that extends into an aperture in the vessel.

17. A kit, comprising:
a vessel having an outside diameter, an inside diameter, a height, a thickness, and a top surface;
a pump having a pump body including an outside diameter that is commensurate to an inside diameter of the vessel, the body including a bell portion which mates with a top surface of the vessel such that the pump body is flush with the vessel in a vertical and horizontal direction
a diffuser having a diffuser body including an outside diameter that is commensurate to an inside diameter of the vessel, the diffuser body including a bell portion which mates with a top surface of the vessel such that the diffuser body is flush with the vessel in a vertical and horizontal direction; and
a candle holder including an outside diameter that is commensurate to an inside diameter of the vessel, the candle holder including a candle mount having an extension portion extending downwardly from a bottom of the candle mount.

18. The kit of claim 17, wherein the vessel further includes an aperture disposed in a bottom of the vessel.

19. The kit of claim 18, further comprising a cap.

20. The kit of claim 19, wherein the cap has an outside diameter that is commensurate with an outside diameter of the vessel and a ring, disposed on the cap, which has an outside diameter that is commensurate with an inside diameter of the vessel.
